(19) United States
(12) Patent Application Publication
(10) Pub. No.: US 2014/0043189 A1
(43) Pub. Date: Feb. 13, 2014

(54) DIELECTRIC RESONATOR ARRAY ANTENNA

(71) Applicants: KOREA UNIVERSITY RESEARCH AND BUSINESS FOUNDATION, (US); SAMSUNG ELECTRO-MECHANICS CO., LTD., Suwon (KR)

(72) Inventors: Jung Aun Lee, Suwon (KR); Moonil Kim, Seongnam-si (KR); Kook Joo Lee, Seoul (KR)

(73) Assignees: KOREA UNIVERSITY RESEARCH AND BUSINESS FOUNDATION, Seoul (KR); SAMSUNG ELECTRO-MECHANICS CO., LTD., Suwon (KR)

(21) Appl. No.: 13/717,577

(22) Filed: Dec. 17, 2012

(30) Foreign Application Priority Data
Aug. 10, 2012 (KR) 10-2012-0087837

(51) Int. Cl. H01Q 13/20; H01Q 3/34

(52) U.S. Cl. CPC H01Q 13/20; H01Q 3/34
USPC 342/368; 343/777

(57) ABSTRACT

Disclosed herein is a dielectric resonator array antenna including one or more series-feed type array elements installed to be arranged in parallel in a multilayer substrate, wherein first high frequency signals having the same or different phases or time delays are adjusted to be applied to the respective series-feed type array elements and respective radiated 1D array beams are individually used or combined to adjust beamforming of 2D array beams. Also, since the series-feed type array element is configured by connecting a plurality of dielectric resonator antennas in series, it can be easily and simply fed in series through coupling generated by the intervals between the feeding lines of the pertinent feeding unit of the plurality of dielectric resonator antennas connected in series. In addition, the broadband characteristics can be obtained by using the plurality of dielectric resonator antennas, whereby the overall antenna performance can be enhanced.

### CROSS REFERENCE TO RELATED APPLICATION

This application claims the benefit of Korean Patent Application No. 10-2012-0087837, filed on Aug. 10, 2012, entitled “Dielectric Resonator Array Antenna”, which is hereby incorporated by reference in its entirety into this application.

### BACKGROUND OF THE INVENTION

1. Technical Field

The present invention relates to a dielectric resonator array antenna.

2. Description of the Related Art

Recently, research into a transmission/reception system utilizing high frequency of a millimeter wave band has been actively conducted, and such a millimeter wave frequency band has the potential of being utilized in various application fields such as short-range wireless communication, a car radar, an image system, and the like.

In particular, it is anticipated that a market for a short-range wireless communication system using a 60 GHz broadband frequency and a car radar system having a 77 GHz band will be in high demand.

In a product of the application fields, a transmission/reception IC chip is generally packaged with an external substrate, and passive circuits including an antenna are fabricated on the external circuit, and here, for a transmission/reception system having a millimeter wave frequency band such as the product of the application fields, the development of a product in the form of a system-on-package (SOP) is required to reduce a loss generated in combining components and lower primary cost and reduce the size of a product through a single process.

As a technique for a single package product, a multilayer process technique of laminating dielectric substrates such as a low temperature co-fired ceramic (LTCC) and a liquid crystal polymer (LCP) has been mainly used, and recently, the development of a product based on a general PCB process and a product using a low-priced organic substrate have been attempted to reduce process costs.

Meanwhile, an array antenna including a plurality of antennas is used to effectively perform communication using limited output power in a wireless communication system and to detect an object through beam-focusing and beam-scanning in a car-radar and image system of the foregoing application fields.

In such an array antenna, a beam pattern may be deformed by adjusting a phase of an input signal (e.g., a high frequency signal) applied to each antenna by using a phase shifter, and the like.

In this case, one-dimensional (1D) beam pattern deformation (i.e., while being fixed in any one of a vertical direction and a horizontal direction, a beam pattern may be deformed in a different direction), rather than a two-dimensional (2D) beam pattern deformation, may be used.

To this end, in a related art multilayer substrate structure environment, a patch antenna having the characteristics of a planar structure, and such patch antennas may be configured as an array.

One of the simplest methods for feeding a related art patch array antenna is distributing input signals having a uniform magnitude to individual antenna elements of the array antenna by using a T-type power divider.

However, the method for feeding the related art patch array antenna is disadvantageous in that a beam pattern is fixed because a phase of an input signal transferred to an individual antenna element is not adjusted, and thus, the method cannot be used in an application field requiring beam forming or beam scanning.

Also, in case that a beam pattern of the related art patch array antenna is intended to be deformed, an individual antenna element should be connected to an individual power supply device of an IC chip in a one-to-one manner, making the configuration of a feeding circuit very complicated.

Thus, the development of an array antenna having a novel structure that may be available for beam pattern deformation of an individual antenna element by using a simple feeding structure, while having broadband and high efficiency characteristics, is urgent.

### SUMMARY OF THE INVENTION

The present invention has been made in an effort to provide a dielectric resonator array antenna in which at least one or more series-feed type array elements, which include a plurality of dielectric resonator antennas arranged in series in a multilayer substrate and are fed in series through coupling, are configured to be arranged in parallel, thus having broadband and high efficiency characteristics.

The present invention has also been made in an effort to provide a dielectric resonator array antenna in which a phase of a pertinent high frequency signal fed through the coupling is adjusted according to a length of a pertinent feeding unit of the plurality of dielectric resonator antennas arranged in series, or the same or different high frequency signals are adjusted to be applied to the respective series-feed type array elements to adjust beamforming (angle and strength (gain and directionality)) of the entire beams radiated from the dielectric resonator array antenna.

According to an embodiment of the present invention, there is provided a dielectric resonator array antenna including one or more series-feed type array elements installed to be arranged in parallel in a multilayer substrate, wherein first high frequency signals having the same or different phases or time delays are adjusted to be applied to the respective series-feed type array elements and respective radiated 1D array beams are individually used or combined to adjust beamforming of 2D array beams.

The respective series-feed type array elements include a plurality of dielectric resonance antennas installed in the multilayer substrate such that they are connected in series at the same or different intervals (L) according to the same or different lengths (l) of pertinent feeding units, wherein when the first high frequency signal is applied to a starting dielectric resonator antenna among the plurality of dielectric resonator antennas, second high frequency signals having phases adjusted to be the same or different from the first high frequency signals according to the lengths (l) of the pertinent feeding units are sequentially coupled from the starting dielectric resonator antenna to the ending dielectric resonator antenna, thus feeding the pertinent dielectric resonator antennas, and beamforming of respective 1D array beams is adjusted by individually using or combining respective antenna beams radiated from the respective dielectric resonator antennas fed by the second high frequency signals.

The respective dielectric resonator antennas may include: a first conductive plate having an opening formed on an upper end of one insulating layer in the multilayer substrate; a second conductive plate formed on a lower end of an insulating layer laminated below at least two or more layers from the first conductive plate and positioned to correspond to the opening; a plurality of first metal via holes electrically connecting interlayers of the respective insulating layers between the first and second conductive plates, and vertically penetrating the multilayer substrate such that a metal boundary interface is formed in a vertical direction to surround the opening of the first conductive plate at predetermined intervals; and feeding units coupled to a next dielectric resonator antenna to feed a dielectric resonator installed in the form of a cavity within the multilayer substrate by applying the second high frequency signal having a phase controlled according to the length l, and apply a corresponding second high frequency signal to a next dielectric resonator antenna connected in series at the interval L, wherein beamforming of the respective antenna beams are adjusted by adjusting a length of a pertinent feeding unit of the respective dielectric resonator antennas and a size of a pertinent dielectric resonator.

An angle of the respective antenna beams may be adjusted according to the length of the pertinent feeding unit, and a strength thereof may be adjusted according to the size of the pertinent dielectric resonator.

The feeding unit may be any one of a transmission line having a coplanar waveguide (CPW) line structure or a transmission line having a strip line structure.

The transmission line having the CPW line structure may include: a feeding line formed as a conductive plate having a line shape extended horizontally to an opening surface of the opening such that one end is inserted into a previous dielectric resonator antenna and the other end is inserted into the corresponding dielectric resonator according to the length (l), feeding the dielectric resonator by the second high frequency signal applied through coupling between the one end and the previous dielectric resonator antenna and applying the second high frequency signal to a next dielectric resonator antenna through coupling between the other end and the next dielectric resonator antenna; a first earth plate formed on the same plane as that of the feeding line and formed to be spaced apart from one side of the feeding line; and a second earth plate formed on the same plane as that of the feeding line and formed to be spaced apart from the other side of the feeding line.

In the transmission line having the CPW line structure, the length (l) of the feeding line may be λ/2<1<L, wherein λ is a frequency wavelength in a pertinent dielectric resonator and L is a length between the centers of pertinent dielectric resonators of mutually neighboring dielectric resonator antennas. Also, the interval (L) may be λ/2 or greater.

In the transmission line having the CPW line structure, the feeding line may be formed on the same plane as that of the first conductive plate, and the first and second earth plates may be integrally formed with the first conductive plate.

The transmission line having the CPW line structure may further include: a third conductive plate positioned to correspond to the feeding line and formed on a lower end of an insulating layer laminated below at one or more layers from the feeding line to form a bottom surface of a waveguide; and a plurality of second metal via holes vertically penetrating the multilayer substrate such that they form a metal boundary interface in a vertical direction at predetermined intervals along the feeding line from the insulating layer on which the feeding line is formed to the third conductive plate, to thus form a lateral surface of the waveguide.

In the transmission line having the CPW line structure, the third conductive plate may be integrally formed with the second conductive plate.

The transmission line having the strip line structure may include: a feeding line formed as a conductive plate having a line shape extended horizontally to an opening surface of the opening such that one end is inserted into a previous dielectric resonator antenna and the other end is inserted into the corresponding dielectric resonator according to the length (l), feeding the dielectric resonator by the second high frequency signal applied through coupling between the one end and the previous dielectric resonator antenna and applying the second high frequency signal to a next dielectric resonator antenna through coupling between the other end and the next dielectric resonator antenna; a first earth plate positioned to correspond to the feeding line and formed on an upper end of an insulating layer laminated above one or more layers from the feeding line; and a second earth plate positioned to correspond to the feeding line and formed on a lower end of an insulating layer laminated below one or more layers from the feeding line.

In the transmission line having the strip line structure, the length (l) of the feeding line may be λ/2<1<L, wherein λ is a frequency wavelength in a pertinent dielectric resonator and L is a length between the centers of pertinent dielectric resonators of mutually neighboring dielectric resonator antennas. Also, in the transmission line having the strip line structure, the interval (L) may be λ/2 or greater.

In the transmission line having the strip line structure, the feeding line may be positioned between a lower end of the insulating layer on which the first conductive plate is formed and an upper end of the insulating layer on which the second conductive plate is formed.

In the transmission line having the strip line structure, the first earth plate may be integrally formed with the first conductive plate, and the second earth plate may be integrally formed with the second conductive plate.

The transmission line having the strip line structure may further include: a third conductive plate positioned to correspond to the feeding line and formed on a lower end of the insulating layer laminated below at least one or more layers from the feeding line to form a bottom surface of the waveguide; and a plurality of second via holes vertically penetrating the multilayer substrate such that they form a metal boundary interface in a vertical direction at certain intervals along the feeding line from the insulating layer on which the feeding line is formed to the third conductive plate, to thus form a lateral surface of the waveguide.

In the transmission line having the strip line structure, the third conductive plate may be integrally formed with the second conductive plate or the second earth plate.

The dielectric resonator array antenna may further include a power source IC configured to include one or more power supply units which individually supply first high frequency signals to the one or more series-feed type array elements or combine the first high frequency signals to simultaneously supply them.

The power source IC may include one or more phase shifters adjusting a phase of a pertinent high frequency signal by interworking with the one or more power supply units.

The power source IC may further include one or more time delay units adjusting a time to delay a pertinent first high frequency signal by interworking with the one or more power supply units.

### BRIEF DESCRIPTION OF THE DRAWINGS

The above and other objects, features, and advantages of the present invention will be more clearly understood from the following detailed description taken in conjunction with the accompanying drawings, in which:

FIG. 1A is a perspective view of a series-feed type array element according to an embodiment of the present invention;

FIG. 1B is a cross-sectional view of the series-feed type array element taken along line A-A′ in FIG. 1A;

FIG. 2A is a perspective view of a series-feed type array element according to another embodiment of the present invention;

FIG. 2B is a cross-sectional view of the series-feed type array element taken along line A-A′ in FIG. 2A;

FIGS. 3A through 3C are cross-sectional views of various series-feed type array element in which a plurality of dielectric resonator antennas are individually adjusted to have different sizes, respectively, according to an embodiment of the present invention;

FIG. 4 is a graph showing a comparison between a reflection coefficient simulation result of the related art single patch antenna and the dielectric resonator antenna used in an embodiment of the present invention;

FIGS. 5A through 5C are graphs showing a comparison between an antenna performance (radiation characteristics) simulation result of the related art patch array antenna and that of the dielectric resonator array antenna according to an embodiment of the present invention;

FIGS. 6A through 6C are views illustrating dielectric resonator array antennas using series-feed type array elements, respectively, according to an embodiment of the present invention;

FIG. 7A is a plan view of a 12×16 dielectric resonator array antenna according to an embodiment of the present invention; and

FIG. 7B is a graph showing an antenna performance (radiation characteristics) simulation result of the 12×16 dielectric resonator array antenna illustrated in FIG. 7A.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

In an embodiment of the present invention, as a multilayer substrate 1, a substrate including four insulating layers and conductive layers laminated is used, but the present invention is not limited thereto.

Also, other conductive layers than the conductive layers illustrating the dielectric resonator antennas including a feeding unit are regarded to be omitted and thus not illustrated.

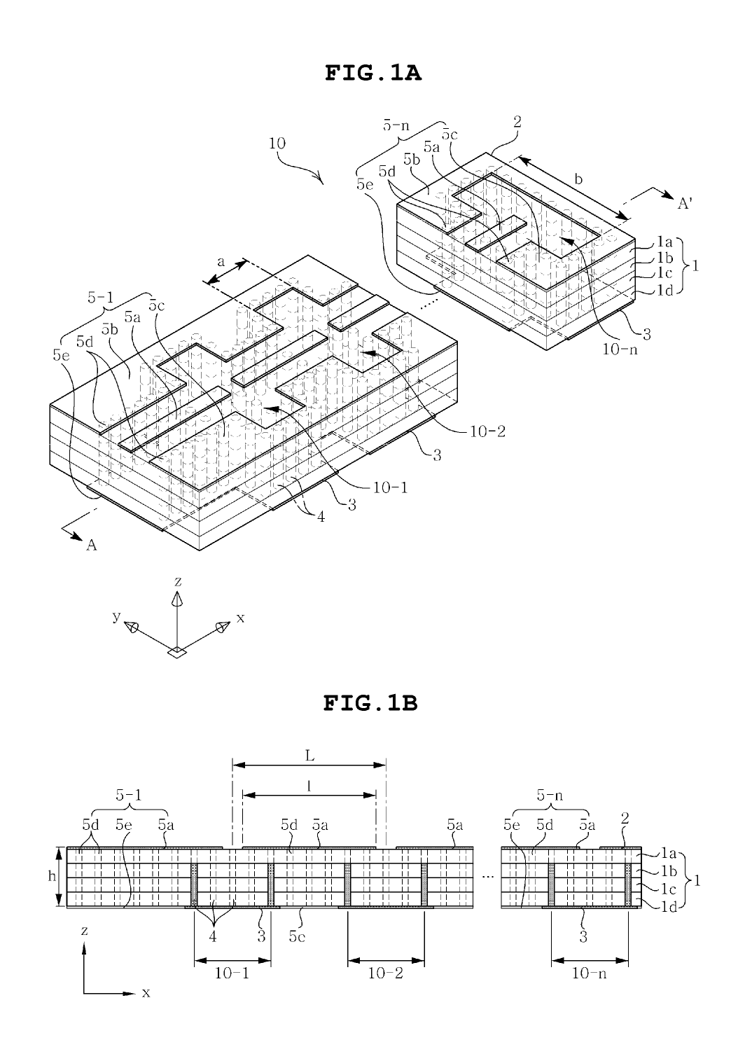

FIG. 1A is a perspective view of a series-feed type array element according to an embodiment of the present invention, and FIG. 1B is a cross-sectional view of the series-feed type array element taken along line A-A′ in FIG. 1A.

Referring to FIGS. 1A and 1B, in a series-feed type array element 10 according to an embodiment of the present invention, a plurality of dielectric resonator antennas 10-1, 10-2, . . . , 10-n are installed to be connected in series at the same or different intervals L according to the same or different lengths l of pertinent feeding units 5-1, . . . , 5-n on a multilayer substrate 1 formed by alternately laminating a plurality of insulating layers 1a to 1d and conductive layers (e.g., 2, 3, and 5).

In the series-feed type array element 10, when a first high frequency signal is applied to a starting dielectric resonator antenna 10-1 (specifically, to the feeding unit 5-1 of the starting dielectric resonator antenna 10-1) among the plurality of dielectric resonator antennas 10-1, 10-2, . . . , 10-n), second high frequency signals having phases adjusted to be the same or different from the first RF signal according to the lengths l of the corresponding feeding units 5-1, . . . , 5-n are sequentially coupled from the starting dielectric resonator antenna 10-1 to the final dielectric resonator antenna 10-n, thus feeding the pertinent dielectric resonator antennas.

Then, respective beams (hereinafter, referred to as ‘antenna beams’ are radiated from the respective dielectric resonator antennas 10-1, 10-2, . . . , 10-n), and the respective antenna beams may be individually used or combined to adjust beamforming of beams (hereinafter, referred to as ‘one-dimensional (1D) array beams’) of the series-feed type array element 10 (i.e., angle and strength (gain and directionality) of the 1D array beams are adjusted).

Here, ‘adjusting beamforming’ refers to adjusting an angle and strength (gain and directionality) of beams, which is used throughout the present disclosure as having the same meaning.

In detail, the respective dielectric resonator antennas 10-1, 10-2, . . . , 10-n include a first conductive plate 2 having an opening formed on an upper end of one insulating layer (e.g., 1a) of the multilayer substrate 1, a second conductive plate 3 formed on a lower end of an insulating layer (e.g., 1d) laminated below at least two or more layers from the first conductive plate 2, a plurality of first metal via holes 4 electrically connecting interlayers of the respective insulating layers 1a to 1d between the first and second conductive plates 2 and 3, and vertically penetrating the multilayer substrate 1 such that a metal boundary interface is formed in a vertical direction to surround the opening of the first conductive plate 2 at certain intervals, and feeding units 5-1, . . . , 5-n coupled to a next dielectric resonator antenna to feed a dielectric resonator installed in the form of a cavity within the multilayer substrate 1 by applying the second high frequency signal having a phase controlled according to the length l, and apply a corresponding second high frequency signal to a next dielectric resonator antenna connected in series at the interval L.

Here, a resonance mode of the dielectric resonator is maintained by using the metal boundary interface in a vertical direction formed by the plurality of second metal via holes 4, a metal boundary interface in a horizontal direction formed by the second conductive plate 3, and a magnetic wall of the opening surface formed on the first conductive plate 2.

An ideal dielectric resonator is required to have a metal boundary interface in a vertical direction of the substrate 1 having the multilayer structure, but it is difficult to fabricate, thus the plurality of first metal via holes 4 arranged at predetermined intervals (e.g., formed to be λ/4 or lower) are used instead.

Also, in FIGS. 1A and 1B, the second conductive plate 3 is illustrated as a conductive plate having a size defined by the plurality of first metal via holes 4, but the size is merely a minimum size for implementing the pertinent dielectric resonator of each dielectric resonator antenna 10-1, 10-2, . . . , or 10-n and a conductive plate having the same size as that of the multilayer substrate 1 may also be used.

The dielectric resonator generally has a hexahedral shape or a cylindrical shape, but the to present invention is not limited thereto and the dielectric resonator may be fabricated to have any forms.

For example, since the plurality of first metal via holes 4 are formed in a vertical direction according to the shape of the opening of the first conductive plate 2, the dielectric resonator may be fabricated to have various polyprism shapes.

Also, the dielectric resonator may be fabricated by adjusting a size thereof according to a desired resonance frequency or strength (gain and directionality). This means that a strength (gain and directionality) of the antenna beams radiated through the opening may be adjusted according to the size of the dielectric resonator.

For example, when the dielectric resonator has a rectangular parallelepiped shape as illustrated in FIGS. 1A and 1B, the dielectric resonator may be fabricated by adjusting a length (a) in a feeding direction (i.e., an x direction), a y directional length (b), and a z-directional length (height) (h) of a feeding line 5a (to be described). Although not shown, when the dielectric resonator has a cylindrical shape, the dielectric resonator may be fabricated by adjusting a diameter (R) and the z-directional length (height) (h).

The feeding line 5a may be formed in any position between the upper end of the insulating layer (e.g., 1a) on which the first conductive plate 2 is formed and the upper end of the insulating layer (e.g., 1d) on which the second conductive plate 3 is formed.

For this reason, the number and positions of the pertinent earth plates 5b and 5c may be changed together according to a position of a pertinent feeding line 5a of the feeding unit 5-1, . . . , or 5-n, and may be implemented by using any one of the various types of transmission lines including a coplanar waveguide (CPW) line structure, a strip line structure, and the like, that may be easily formed on the multilayer substrate 1 according to the configuration of the feeding line 5a and the pertinent earth plates 5b and 5c.

For example, when the feeding line 5a is formed on the same layer (i.e., on the upper end of the insulating layer 1a) as that of the first conductive plate 2 as illustrated in FIGS. 1A and 1B, the feeding unit 5-1, . . . , or 5-n including the feeding line 5a may be configured as a transmission line having a CPW line structure.

In detail, as illustrated in FIG. 1A, the feeding unit 5-1, . . . , or 5-n implemented as a transmission line having the CPW line structure includes the feeding line 5a formed on the same layer as that of the first conductive plate 2, the first earth plate 5b formed on the same plane as that of the feeding line 5a such that it is spaced apart from one side of the feeding line 5a, and the second earth plate 5c formed on the same plane as that of the feeding line 5a such that it is spaced apart from the other side of the feeding line 5a.

Here, the first and second earth plates 5b and 5c may be integrally formed with the first conductive plate 2.

Also, the feeding unit 5-1, . . . , or 5-n implemented as a transmission line having the CPW line structure may further include a third conductive plate 5e positioned to correspond to the feeding line 5a and formed on a lower end of the insulating layer (e.g., 1b) laminated below of one or more layers from the feeding line 5a to form a bottom surface of a waveguide, and a plurality of second metal via holes 5d vertically penetrating the multilayer substrate 1 such that they form a metal boundary interface in a vertical direction at certain intervals along the feeding line 5a from the insulating layer 1a on which the feeding line 5a is formed to the third conductive plate 5e, to thus form a lateral surface of the waveguide.

Here, the third conductive plate 5e may be integrally formed with the second conductive plate 3.

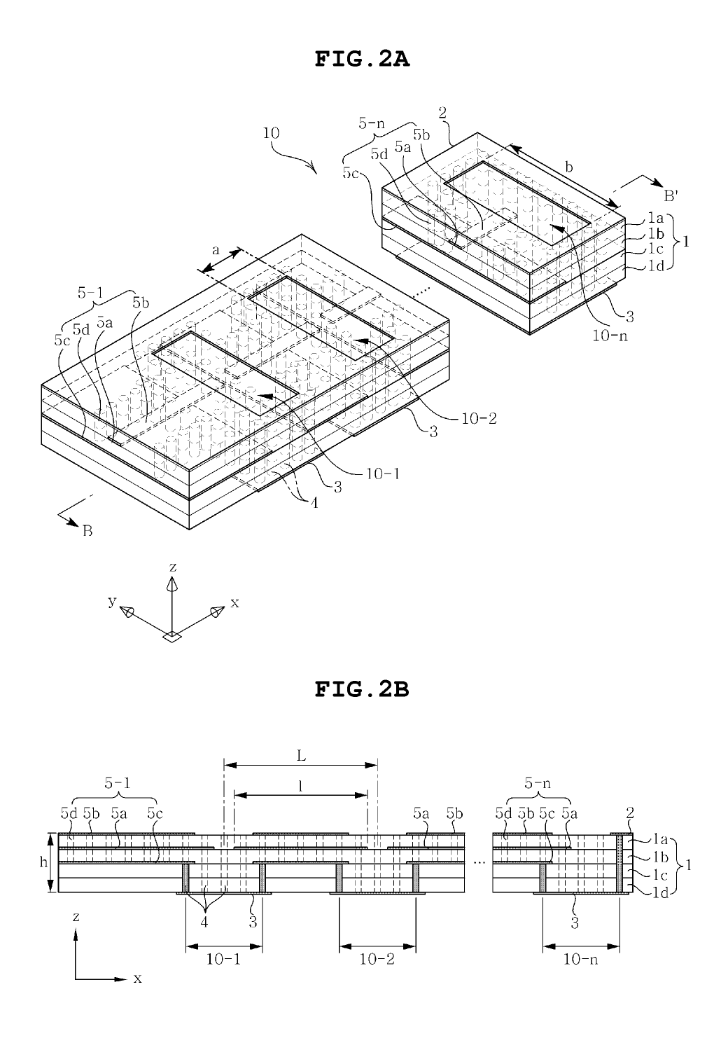

Meanwhile, the feeding line 5a may also be positioned within the dielectric resonators 10-1, 10-2, . . . , or 10-n as mentioned above, which will be described in detail with reference to FIGS. 2A and 2B.

FIG. 2A is a perspective view of a series-feed type array element according to another embodiment of the present invention, and FIG. 2B is a cross-sectional view of the series-feed type array element taken along line B-B′ in FIG. 2A.

The series-feed type array element 10 illustrated in FIGS. 2A and 2B are the same as the series-feed type array element 10 illustrated in FIGS. 1A and 1B illustrated in FIGS. 1A and 1B, except for a structure of the feeding units 5-1, . . . , 5-n, so a detailed description of the same components will be replaced by the foregoing description.

As illustrated in FIGS. 2A and 2B, when the feeding line 5a is formed within the dielectric resonators 10-1, 10-2, . . . , 10-n (namely, when the feeding line 5a is formed between a lower end of the insulating layer 1a on which the second conductive plate 2 is formed and an upper end of the insulating layer 1d on which the second conductive plate 3 is formed), the feeding unit 5-1, . . . , or 5-n including such a feeding line 5a may be configured as a transmission line having a strip line structure.

In detail, the feeding line 5-1, . . . , or 5-n implemented as a transmission line having the strip line structure includes the feeding line 5a formed on any one layer (e.g., between the first and second insulating layers 1a and 1b) among layers from a lower end of the insulating layer 1a on which the second conductive plate 2 is formed to an upper end of the insulating layer 1d on which the second conductive plate 3 is formed, a first earth plate 5b positioned to correspond to the feeding line 5a and formed on an upper end of an insulating layer (e.g., 1a) laminated above at least one or more insulating layers from the feeding line 5a, and a second earth plate 5c positioned to correspond to the feeding line 5a and formed on a lower end of an insulating layer (e.g., 1b) laminated below at least one or more insulating layers from the feeding line 5a.

Here, the first earth plate 5b may be integrally formed with the first conductive plate 2, and the second earth plate 5c may be integrally formed with the second conductive plate 3.

Also, the feeding unit 5-1, . . . , or 5-n implemented as a transmission line having the strip line structure may further include a third conductive plate (not shown) positioned to correspond to the feeding line 5a and formed on a lower end of the insulating layer (e.g., 1b) laminated below at least one or more layers from the feeding line 5a to form a bottom surface of the waveguide, and a plurality of second via holes 5d vertically penetrating the multilayer substrate 1 such that they form a metal boundary interface in a vertical direction at certain intervals along the feeding line 5a from the insulating layer 1a on which the feeding line 5a is formed to the third conductive plate 5e, to thus form a lateral surface of the waveguide.

Here, the third conductive plate 5e may be integrally formed with the second conductive plate 3 or the second earth plate 5c.

The series-feed type array element 10 according to an embodiment of the present invention may be individually installed in the multilayer substrate 1 such that the size, shape, length, position, and the like, of pertinent dielectric resonators and pertinent feeding units of the plurality of the dielectric resonator antennas 10-1, 10-2, . . . , 10-n are the same or different.

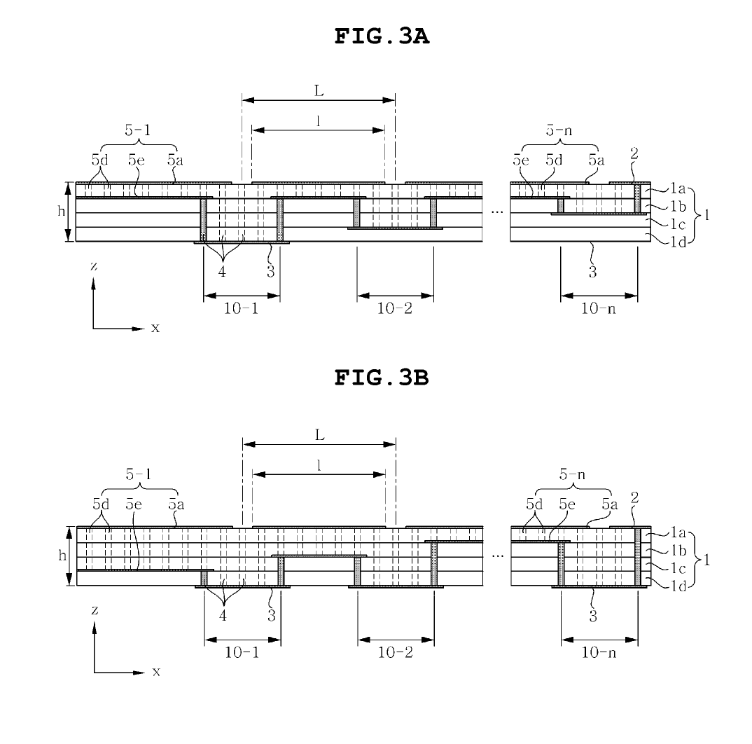

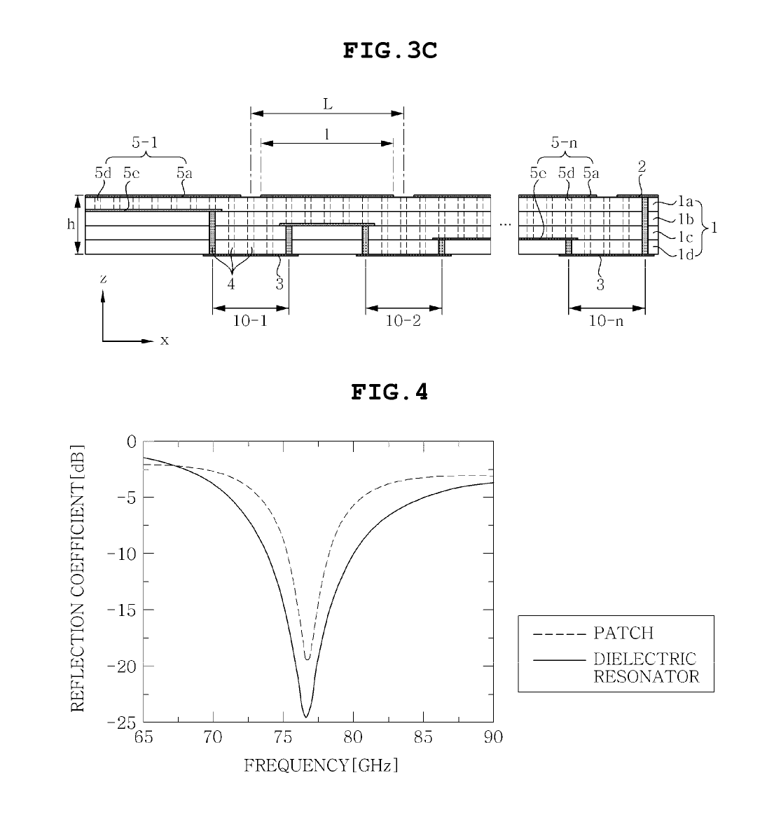

FIGS. 3A through 3C are cross-sectional views of various series-feed type array element in which a plurality of dielectric resonator antennas are individually adjusted to have different sizes, respectively, according to an embodiment of the present invention.

Referring to FIGS. 3A through 3C, a plurality of dielectric resonator antennas 10-1, 10-2, . . . , 10-n according to an embodiment of the present invention are installed in the multilayer substrate 1 such that the sizes thereof are decreased (specifically, the heights (h) are different) (See FIG. 3A), a plurality of dielectric resonator antennas 10-1, 10-2, . . . , 10-n according to an embodiment of the present invention are installed in the multilayer substrate 1 such that the sizes of the plurality of feeding units 5-1, . . . , 5-n according to an embodiment of the present invention are decreased (specifically, the heights (h) are different) (See FIG. 3B), or a plurality of dielectric resonator antennas 10-1, 10-2, . . . , 10-n according to an embodiment of the present invention are installed in the multilayer substrate 1 such that the sizes of the plurality of feeding units 5-1, . . . , 5-n according to an embodiment of the present invention are increased.

Also, although not shown, the plurality of dielectric resonator antennas 10-1, 10-2, . . . , 10-n may be individually installed in the multilayer substrate 1 such that the sizes of (the sizes according to the x-directional length (a) and the y-directional length (b), as well as the sizes according to the height (h) as shown in FIG. 3A, can be adjusted) or the shapes (they may have a cylindrical shape or polyprism shape, as well as a rectangular parallelepiped shape as shown in FIG. 3A) of the respective dielectric resonators are the same or different.

Similarly, the plurality of feeding units 5-1, . . . , 5-n may also be individually installed such that the sizes (sizes according to the x-directional length (not shown) and the y-directional length (l), as well as the sizes according to the height (h) as shown in FIGS. 3B and 3C, can also be adjusted) of the respective feeding units are the same or different.

Accordingly, in the plurality of dielectric resonator antennas 10-1, 10-2, . . . , 10-n, a pertinent resonance frequency and a strength (gain and directionality) of a pertinent antenna beam may be adjusted according to the size of a pertinent dielectric resonator.

Also, in the plurality of dielectric resonator antennas 10-1, 10-2, . . . , 10-n, since a phase of a second high frequency signal applied to a pertinent dielectric resonator is controlled according to a length of a pertinent feeding unit 5-1, . . . , or 5-n (specifically, the length (l) of a pertinent feeding line 5a), an angle (i.e., a slope) of a pertinent antenna beam can be adjusted.

Namely, as described above, beamforming of respective antenna beams radiated from the plurality of dielectric resonator antennas 10-1, 10-2, . . . , 10-n may be adjusted (i.e., the angle and strength (gain and directionality)) of the respective antenna beams may be adjusted) by adjusting a length of a pertinent feeding unit and a size of a pertinent dielectric resonator.

FIG. 4 is a graph showing a comparison between a reflection coefficient simulation result of the related art single patch antenna and the dielectric resonator antenna used in an embodiment of the present invention.

As illustrated in FIG. 4, when compared at the reflection coefficient of −10[dB], it can be seen that a frequency bandwidth of the series-feed type array element used in an embodiment of the present invention is broader than that of the related art single patch antenna.

It means that the dielectric resonator antenna used in an embodiment of the present invention has band characteristics as much as it has a broader frequency bandwidth than that of the related art single patch antenna.

Thus, the dielectric resonator array antenna including a plurality of the dielectric resonator antennas having such broadband characteristics can also have broadband characteristics having a frequency bandwidth broader than that of the patch array antenna including a plurality of patch antennas.

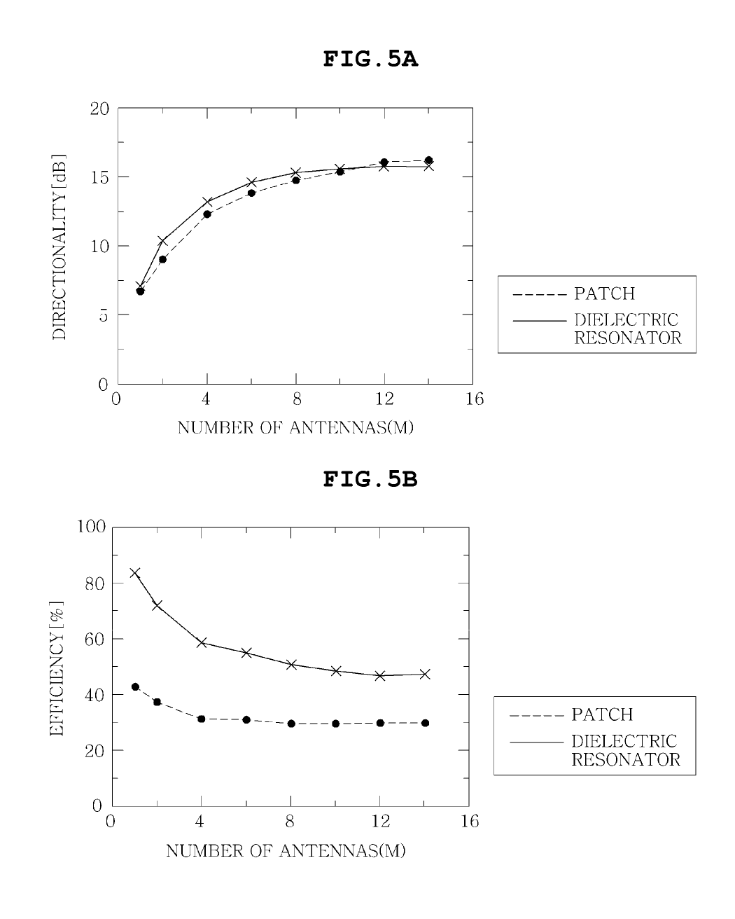

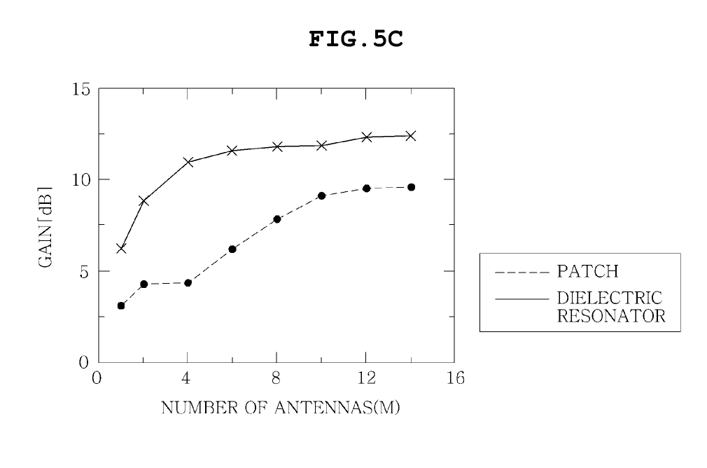

FIGS. 5A through 5C are graphs showing a comparison between an antenna performance (radiation characteristics) simulation result of the related art patch array antenna and that of the dielectric resonator array antenna according to an embodiment of the present invention. Specifically, FIG. 5A shows a comparison between directionalities of the array antennas according to the number of antennas, FIG. 5B shows a comparison between efficiencies of array antennas according to the number of antennas, and FIG. 5C compares gains of array antennas according to the number of antennas.

As illustrated in FIG. 5A, it can be seen that the directionality of the related art patch array antenna and that of the dielectric resonator array antenna according to an embodiment of the present invention according to the number of antennas are almost similar.

It means that the dielectric resonator array antenna according to an embodiment of the present invention has a radiation pattern similar to that of the related art patch array antenna and directionality as excellent as that of the relate art patch array antenna.

In comparison, as illustrated in FIGS. 5B and 5C, it can be seen that the dielectric resonator array antenna according to an embodiment of the present invention implemented to have the same number of antennas as that of the related art patch array antenna has significantly higher efficiency and gain than those of the related art patch array antenna.

It means that even if the dielectric resonator array antenna according to an embodiment of the present invention has a smaller number of antennas than that of the related art patch array antenna, the dielectric resonator array antenna according to an embodiment of the present invention can have the same antenna efficiency and gain as those of the related art patch array antenna.

Namely, the dielectric resonator array antenna according to an embodiment of the present invention has excellent antenna directionality similar to that of the related art patch array antenna and is superior to the related art patch array antenna in the antenna efficiency and gain, exhibiting overall enhanced antenna performance.

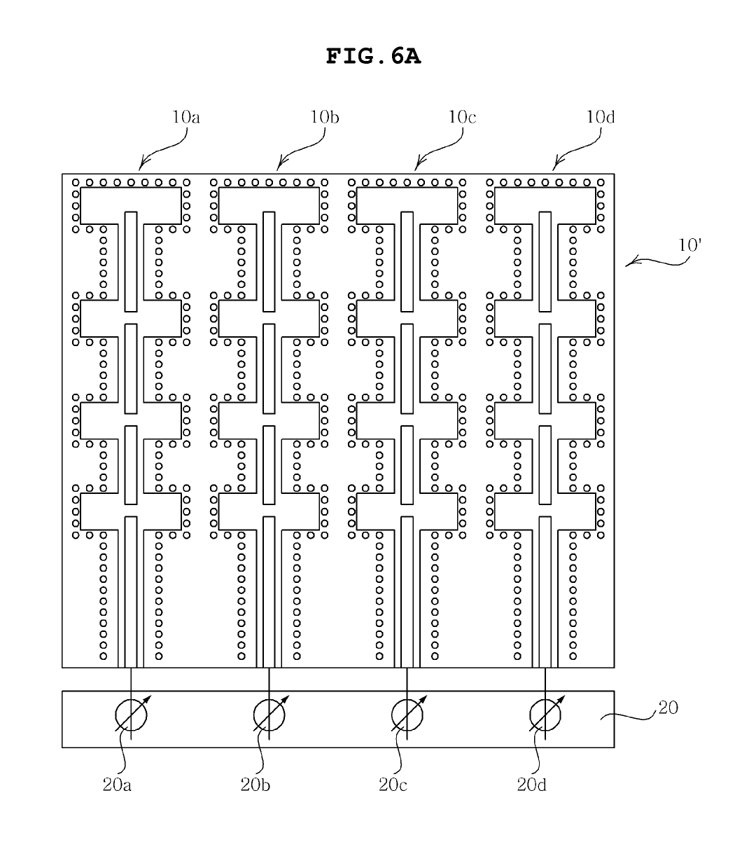

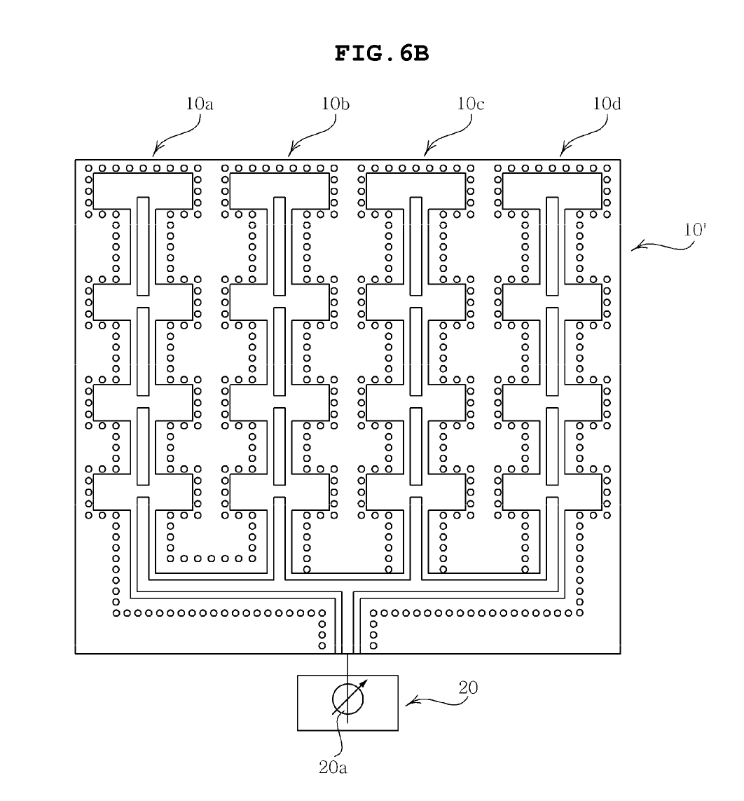

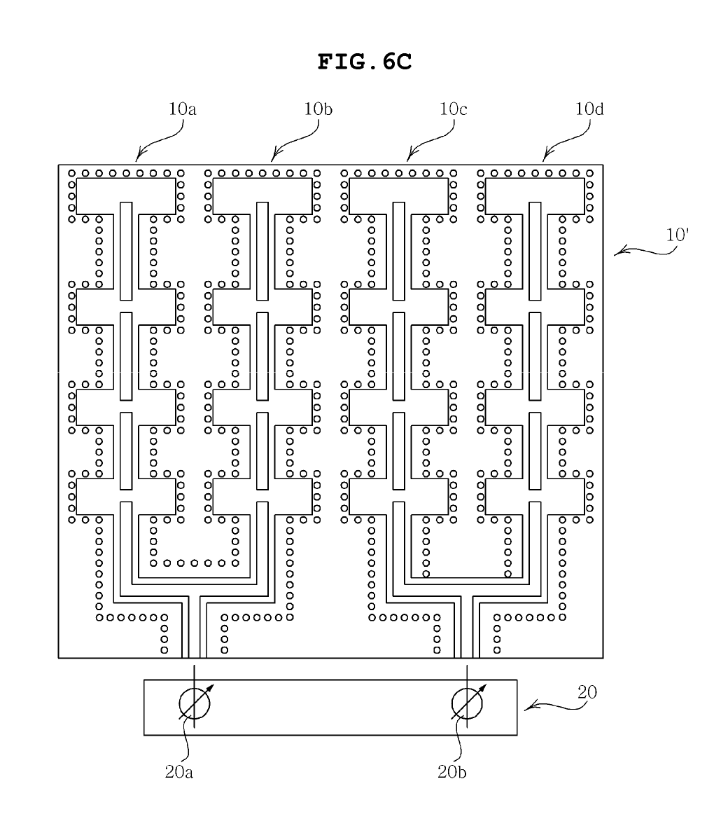

FIGS. 6A through 6C are views illustrating dielectric resonator array antennas using series-feed type array elements, respectively, according to an embodiment of the present invention.

Referring to FIGS. 6A through 6C, 2D dielectric resonator array antennas 10′ are configured by arranging one or more of the series-feed type array elements according to an embodiment of the present invention in parallel on the multilayer substrate 1.

In FIGS. 6A through 6C, the 2D dielectric resonator array antennas 10′ include four series-feed type array elements (e.g., 10a, 10b, 10c, and 10d) arranged on the multilayer substrate 1.

A power source IC 20 connected to the 2D dielectric resonator array antenna 10′ may apply power to the 2D dielectric resonator array antenna 10′ according to various methods.

For example, as illustrated in FIG. 6A, the power source IC 20 may be configured to include four power supply units 20a, 20b, 20c, and 20d corresponding to the four series-feed type array elements 10a, 10b, 10c, and 10d, respectively, and apply a first high frequency signal to the corresponding series-feed type array elements 10a, 10b, 10c, and 10d, respectively.

Also, as illustrated in FIG. 6B, the power source IC 20 may be configured to include a single power supply device 20a and simultaneously apply a first high frequency signal to the four series-feed type array elements 10a, 10b, 10c, and 10d.

Also, as shown in FIG. 6C, the power source IC 20 may be configured to include two power supply units 20a and 20b, and one power supply unit 20a may simultaneously apply a first high frequency signal to two series-feed type array elements 10a and 10b and the other power supply unit 20b may simultaneously apply a first high frequency signal to the other two series-feed type array elements 10c and 10d.

Here, as illustrated in FIGS. 6A and 6C, the power source IC 20 including a plurality of power supply units 20a to 20d, may apply first high frequency signals having the same or different phases or time delays to the corresponding series-feed type array elements 10a, 10b, 10c, and 10d.

Accordingly, as for beams radiated from the 2D dielectric resonator array antenna 10′, first high frequency signals may be adjusted to have the same or different phases or time delays and applied to the series-feed type array elements 10a, 10b, 10c, and 10d, and 1D array beams radiated from the four series-fee type array elements 10a, 10b, 10c, and 10d may be individually used or combined to adjust beamforming of the 2D array beams (i.e., an angle and strength (gain and directionality) of the 2D array beams may be adjusted).

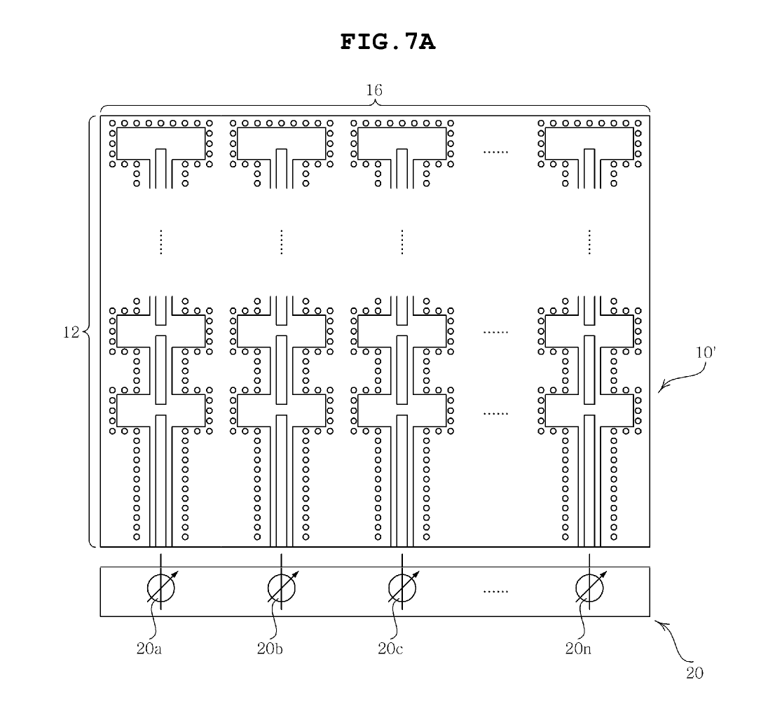

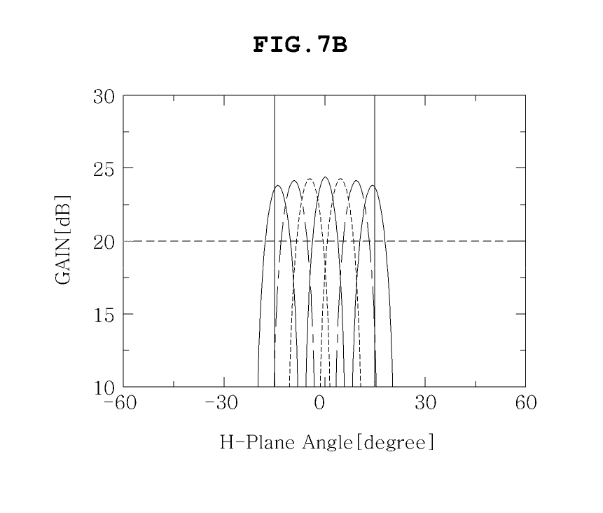

FIG. 7A is a plan view of a 12×16 dielectric resonator array antenna according to an embodiment of the present invention, and FIG. 7B is a graph showing an antenna performance (radiation characteristics) simulation result of the 12×16 dielectric resonator array antenna illustrated in FIG. 7A.

As illustrated in FIG. 7A, in the 12×16 2D dielectric resonator array antenna 10′, sixteen series-feed type array elements, each formed by connecting twelve dielectric resonators 10-1, . . . , 10-12 in series, are arranged in parallel on the multilayer substrate 1.

Here, for the 12×16 2D dielectric resonator array antenna 10′, a power source IC 20 including sixteen power supply units 20-1 to 20-n connected to the respective (i.e., sixteen) series-feed type array elements and applying high frequency signals thereto is used.

FIG. 7B shows directions and gains of 2D array beams when first high frequency signals having the same or different phases or time delays are applied by the pertinent power supply units 20a to 20p such that the respective series-feed type array elements 10a to 10p of the 12×16 2D dielectric resonator array antenna 10′ radiate 1D array beams, respectively.

For example, a middle solid line indicates a case in which the sixteen series-feed type array elements are simultaneously fed by the same first high frequency signals, and here, the 12×16 2D dielectric resonator array antenna 10′ has an H-plane angle of 0° (i.e., radiated to the front) and a gain of about 24 dB.

The other curves of the graph indicate cases in which first high frequency signals having different phases or time delays are applied to the respective power supply units 20a to 20p in feeding the sixteen series-feed type array elements 10a to 10p, and here, the H-plane angles are within a range of ±30° according to the phases or time delays of the first high frequency signals and gains are about 23 to 24 dB.

Here, it can be seen that, no matter whether or not the sixteen series-feed type array elements 10a to 10p are simultaneously fed or individually fed by providing a phase difference or time difference, gains of the 12×16 2D dielectric resonator array antenna 10′ are all 20 dB or greater.

As described above, according to embodiments of the present invention, since one or more series-feed type array elements 10 are installed to be arranged in parallel in the multilayer substrate 1, beamforming of 2D array beams can be easily adjusted by adjusting such that high frequency signals having the same or different phases or time delays are applied to the respective series-feed type array elements 10.

Also, since the series-feed type array elements 10 are configured by connecting a plurality of dielectric resonator antennas 10-1, 10-2, . . . , 10-n in series, the feeding lines 5a of the plurality of dielectric resonator antennas 10-1, 10-2, . . . , 10-n are arranged in series at certain intervals, and the plurality of dielectric resonator antennas 10-1, 10-2, . . . , 10-n can be simply and easily fed in series through coupling generated by the intervals between mutually neighboring feeding lines 5a.

In addition, also as for the plurality of dielectric resonator antennas 10-1, 10-2, . . . , 10-n constituting the series-feed type array element 10, an angle of a pertinent antenna beam may be adjusted according to the length (l) of a pertinent feeding unit 5-1, . . . , or 5-n, respectively, or a strength (gain and directionality) of a pertinent antenna beam may be adjusted according to the size of a pertinent dielectric resonator, whereby beamforming of 1D array beams radiated from the respective series-feed type array elements 10 can be easily adjusted.

Also, since the dielectric resonator array antenna 10′ is configured by using the plurality of dielectric resonator antennas 10-1, 10-2, . . . , 10-n, broadband characteristics can be obtained, and since an antenna gain is enhanced according to the number of the plurality of dielectric resonator antennas 10-1, 10-2, . . . , 10-n to have high efficiency characteristics, the overall antenna performance can be enhanced.

According to the embodiments of the present invention, beamforming (angle and strength (gain and directionality)) of antenna beams respectively radiated from the plurality of dielectric resonator antennas can be easily adjusted by adjusting the size of a pertinent dielectric resonator and the length of a pertinent feeding unit of the plurality of dielectric resonator antennas.

Also, the series-feed type array element configured by connecting the plurality of dielectric resonator antennas in series can be easily and simply fed in series through coupling generated by the intervals between the feeding lines of the pertinent feeding unit of the plurality of dielectric resonator antennas connected in series, and beamforming (angle and strength (gain and directionality)) of 1D array beams radiated from the series-feed type array element can be easily adjusted by individually using the respective antennas beams or combining them.

In addition, in the dielectric resonator array antenna configured by arranging one or more of the series-feed type array elements in parallel, high frequency signals having the same or different phases or time delays are adjusted to be applied to the respective series-feed type array elements, and respective 1D array beams are individually used or combined to easily adjust beamforming (angle and strength (gain and directionality)) of 2D array beams.

Also, since the dielectric resonator array antenna is configured by using the plurality of dielectric resonator antennas, broadband characteristics can be obtained, and since an antenna gain is enhanced according to the number of the plurality of dielectric resonator antennas to have high efficiency characteristics, the overall antenna performance can be enhanced.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A dielectric resonator array antenna comprising one or more series-feed type array elements installed to be arranged in parallel in a multilayer substrate,
wherein first high frequency signals having the same or different phases or time delays are adjusted to be applied to the respective series-feed type array elements and respective radiated 1D array beams are individually used or combined to adjust beamforming of 2D array beams.

2. The dielectric resonator array antenna as set forth in claim 1, wherein the respective series-feed type array elements include a plurality of dielectric resonance antennas installed in the multilayer substrate such that they are connected in series at the same or different intervals (L) according to the same or different lengths (l) of pertinent feeding units,
wherein when the first high frequency signal is applied to a starting dielectric resonator antenna among the plurality of dielectric resonator antennas, second high frequency signals having phases adjusted to be the same or different from the first high frequency signals according to the lengths (l) of the pertinent feeding units are sequentially coupled from the starting dielectric resonator antenna to the ending dielectric resonator antenna, thus feeding the pertinent dielectric resonator antennas, and
beamforming of respective 1D array beams is adjusted by individually using or combining respective antenna beams radiated from the respective dielectric resonator antennas fed by the second high frequency signals.

3. The dielectric resonator array antenna as set forth in claim 2, wherein the respective dielectric resonator antennas include:
a first conductive plate having an opening formed on an upper end of one insulating layer in the multilayer substrate;
a second conductive plate formed on a lower end of an insulating layer laminated below at least two or more layers from the first conductive plate and positioned to correspond to the opening;
a plurality of first metal via holes electrically connecting interlayers of the respective insulating layers between the first and second conductive plates, and vertically penetrating the multilayer substrate such that a metal boundary interface is formed in a vertical direction to surround the opening of the first conductive plate at certain intervals; and
feeding units coupled to a next dielectric resonator antenna to feed a dielectric resonator installed in the form of a cavity within the multilayer substrate by applying the second high frequency signal having a phase controlled according to the length l, and apply a corresponding second high frequency signal to a next dielectric resonator antenna connected in series at the interval L,
wherein beamforming of the respective antenna beams are adjusted by adjusting a length of a pertinent feeding unit of the respective dielectric resonator antennas and a size of a pertinent dielectric resonator.

4. The dielectric resonator array antenna as set forth in claim 3, wherein an angle of the respective antenna beams is adjusted according to the length of the pertinent feeding unit, and a strength thereof is adjusted according to the size of the pertinent dielectric resonator.

5. The dielectric resonator array antenna as set forth in claim 3, wherein the feeding unit is any one of a transmission line having a coplanar waveguide (CPW) line structure or a transmission line having a strip line structure.

6. The dielectric resonator array antenna as set forth in claim 5, wherein the transmission line having the CPW line structure includes:
a feeding line formed as a conductive plate having a line shape extended horizontally to an opening surface of the opening such that one end is inserted into a previous dielectric resonator antenna and the other end is inserted into the corresponding dielectric resonator according to the length (l), feeding the dielectric resonator by the second high frequency signal applied through coupling between the one end and the previous dielectric resonator antenna and applying the to second high frequency signal to a next dielectric resonator antenna through coupling between the other end and the next dielectric resonator antenna;
a first earth plate formed on the same plane as that of the feeding line and formed to be spaced apart from one side of the feeding line; and
a second earth plate formed on the same plane as that of the feeding line and formed to be spaced apart from the other side of the feeding line.

7. The dielectric resonator array antenna as set forth in claim 6, wherein the length (l) of the feeding line is λ/2<1<L, wherein λ is a frequency wavelength in a pertinent dielectric resonator and L is a length between the centers of pertinent dielectric resonators of mutually neighboring dielectric resonator antennas.

8. The dielectric resonator array antenna as set forth in claim 6, wherein the interval (L) is λ/2 or greater.

9. The dielectric resonator array antenna as set forth in claim 6, wherein the feeding line is formed on the same plane as that of the first conductive plate.

10. The dielectric resonator array antenna as set forth in claim 6, wherein the first and second earth plates are integrally formed with the first conductive plate.

11. The dielectric resonator array antenna as set forth in claim 6, wherein the transmission line having the CPW line structure further includes:
a third conductive plate positioned to correspond to the feeding line and formed on an lower end of an insulating layer laminated below at one or more layers from the feeding line to form a bottom surface of a waveguide; and
a plurality of second metal via holes vertically penetrating the multilayer substrate such that they form a metal boundary interface in a vertical direction at certain intervals along the feeding line from the insulating layer on which the feeding line is formed to the third conductive plate, to thus form a lateral surface of the waveguide.

12. The dielectric resonator array antenna as set forth in claim 11, wherein the third conductive plate is integrally formed with the second conductive plate.

13. The dielectric resonator array antenna as set forth in claim 5, wherein the transmission line having the strip line structure includes:
a feeding line formed as a conductive plate having a line shape extended horizontally to an opening surface of the opening such that one end is inserted into a previous dielectric resonator antenna and the other end is inserted into the corresponding dielectric resonator according to the length (l), feeding the dielectric resonator by the second high frequency signal applied through coupling between the one end and the previous dielectric resonator antenna and applying the second high frequency signal to a next dielectric resonator antenna through coupling between the other end and the next dielectric resonator antenna;
a first earth plate positioned to correspond to the feeding line and formed on an upper end of an insulating layer laminated above one or more layers from the feeding line; and
a second earth plate positioned to correspond to the feeding line and formed on a lower end of an insulating layer laminated below one or more layers from the feeding line.

14. The dielectric resonator array antenna as set forth in claim 13, wherein the length (l) of the feeding line is λ/2<1<L, wherein λ is a frequency wavelength in a pertinent dielectric resonator and L is a length between the centers of pertinent dielectric resonators of mutually neighboring dielectric resonator antennas.

15. The dielectric resonator array antenna as set forth in claim 14, wherein the interval (L) is λ/2 or greater.

16. The dielectric resonator array antenna as set forth in claim 13, wherein the feeding line is positioned between a lower end of the insulating layer on which the first conductive plate is formed and an upper end of the insulating layer on which the second conductive plate is formed.

17. The dielectric resonator array antenna as set forth in claim 13, wherein the first earth plate is integrally formed with the first conductive plate.

18. The dielectric resonator array antenna as set forth in claim 13, wherein the second earth plate is integrally formed with the second conductive plate.

19. The dielectric resonator array antenna as set forth in claim 13, wherein the transmission line having the strip line structure further includes:
a third conductive plate positioned to correspond to the feeding line and formed on a lower end of the insulating layer laminated below at least one or more layers from the feeding line to form a bottom surface of the waveguide; and
a plurality of second via holes vertically penetrating the multilayer substrate such that they form a metal boundary interface in a vertical direction at certain intervals along the feeding line from the insulating layer on which the feeding line is formed to the third conductive plate, to thus form a lateral surface of the waveguide.

20. The dielectric resonator array antenna as set forth in claim 19, wherein the third conductive plate is integrally formed with the second conductive plate or the second earth plate.

21. The dielectric resonator array antenna as set forth in claim 1, further comprising:
a power source IC configured to include one or more power supply units which individually supply first high frequency signals to the one or more series-feed type array elements or combine the first high frequency signals to simultaneously supply them.

22. The dielectric resonator array antenna as set forth in claim 21, wherein the power source IC includes one or more phase shifters adjusting a phase of a pertinent high frequency signal by interworking with the one or more power supply units.

23. The dielectric resonator array antenna as set forth in claim 21, wherein the power source IC includes one or more time delay units adjusting a time to delay a pertinent first high frequency signal by interworking with the one or more power supply units.
